(19) United States
(12) Patent Application Publication
(10) Pub. No.: US 2024/0383341 A1
(43) Pub. Date: Nov. 21, 2024

(54) ELECTRIC POWER SYSTEM FOR AN ELECTRIC DRIVE SYSTEM AND METHOD OF CONTROLLING THEREOF

(71) Applicant: SCALVY, INC., Santa Clara, CA (US)

(72) Inventors: Mohamed Osama Anwar BADAWY, Santa Clara, CA (US); Amr IBRAHEM, Santa Clara, CA (US)

(73) Assignee: SCALVY, INC., Santa Clara, CA (US)

(21) Appl. No.: 18/785,334

(22) Filed: Jul. 26, 2024

Related U.S. Application Data
(63) Continuation of application No. PCT/US2023/011513, filed on Jan. 25, 2023.
(60) Provisional application No. 63/303,283, filed on Jan. 26, 2022.

(51) Int. Cl. B60L 15/00; B60L 1/00; H02P 27/06

(52) U.S. Cl. CPC B60L 15/007; H02P 27/06; B60L 1/003; B60L 2210/10; B60L 2210/40

(57) ABSTRACT

An electric power system for a vehicle includes one or more power conversion systems electrically connected in parallel for each phase of an electric motor of an electric drive system. Each power conversion system is electrically coupled to a set of energy storage modules from among a plurality of energy storage modules of an energy storage pack. Each power conversion systems includes a power circuit and a power controller. The power circuit is electrically coupled to a respective set of energy storage modules and configured to provide a drive power output to the electric drive system and an auxiliary power output to a power bus. The power controller is configured to control the power circuit to provide the drive power output based on a desired power output of the electric drive system.

### CROSS-REFERENCE TO RELATED APPLICATIONS

This application is a continuation of International Application No. PCT/US2023/011513, filed on Jan. 25, 2023, which claims priority to and the benefit of U.S. Provisional Application No. 63/303,283, filed on Jan. 26, 2022. The disclosures of the above applications are incorporated herein by reference in their entireties.

### FIELD

The present disclosure relates to an electric power system for an electric drive system for a vehicle.

### BACKGROUND

The statements in this section merely provide background information related to the present disclosure and may not constitute prior art.

Electric vehicles, which can include ground and aerial vehicles, are generally powered by an electric power system that provides power to an electric drive system having electric motors, and to one or more power buses for powering additional devices of the electric vehicle. Current architecture used for an electric power system can have some challenges. For example, current electric drive systems can require design customization for every model leading to slower component development and to non-scalable electric power systems that can limit opportunities for simple upgrades. Furthermore, the current architecture of electric power systems can use filtering units potentially leading to an increase in size and weight of the system. These and other issues related to electric power systems are addressed by the present disclosure.

### SUMMARY

This section provides a general summary of the disclosure and is not a comprehensive disclosure of its full scope or all of its features.

In one form, the present disclosure is directed to an electric power system for a vehicle, where the vehicle includes a power bus, an electric drive system, and an energy storage pack. The electric power system includes one or more power conversion systems electrically connected in parallel for each phase of an electric motor of the electric drive system. Each power conversion system is electrically coupled to a set of energy storage modules from among a plurality of energy storage modules of the energy storage pack. Each power conversion system includes a power circuit and a power controller. The power circuit is electrically coupled to a respective set of energy storage modules and configured to provide a drive power output to the electric drive system and an auxiliary power output to the power bus. The power controller is configured to control the power circuit to provide the drive power output based on a desired power output of the electric drive system.

The following includes variations of the electric power system of the above paragraph, which may be implemented individually or in any combination.

In some variations, the power circuit includes a three-level direct current-to-alternating current (DC-to-AC) inverter configured to provide the drive power output.

In some variations, the power circuit includes a direct current-to-direct current (DC-to-DC) circuit configured to provide the auxiliary power output to the power bus.

In some variations, the DC-to-DC converters of the power circuits of at least two power conversion systems from among the one or more power conversion systems are electrically coupled in series to provide respective auxiliary power outputs to the power bus. In some variations, the DC-to-DC converters of the power circuits of at least two power conversion systems from among the one or more power conversion systems are electrically coupled in parallel to provide respective auxiliary power outputs to the power bus.

In some variations, the vehicle includes a plurality of power buses, and the DC-to-DC converters of the power circuits of at least two power conversion systems from among the one or more power conversion systems are electrically coupled to provide respective auxiliary power outputs to a first power bus from among the plurality of power buses, and the DC-to-DC converter of the power circuit of a third power conversion system from among the one or more power conversion systems is configured provide respective auxiliary power output to a second power bus from among the plurality of power buses.

In some variations, the power circuit includes a three-level direct current-to-alternating current (DC-to-AC) inverter configured to provide the drive power output, and a direct current-to-direct current (DC-to-DC) circuit configured to provide the auxiliary power output the power bus, where the DC-to-AC inverter and DC-to-DC converter are electrically isolated from each other.

In some variations, the vehicle includes a plurality of the power buses, and the power circuit of a first power conversion system from among the one or more power conversion systems is configured to provide respective auxiliary power output to a first power bus from among the plurality of the power buses, and the power circuit of a second power conversion system from among the one or more power conversion systems is configured to provide respective auxiliary power output to a second power bus from among the plurality of the power buses.

In some variations, each power conversion system includes a plurality of the power circuits and a plurality of the power controllers forming a plurality of sub-system modules configured to provide the drive power output and the auxiliary power output. Each sub-system module among the plurality of sub-system modules includes: one power circuit from among the plurality of the power circuits, electrically coupled to a subset of energy storage modules, where the subset of energy storage modules are selected from among the set of energy storage modules; and one power controller from among the plurality of the power controllers configured to control the one power circuit.

In some variations, the power controller of the power conversion system is configured to: obtain a desired power output, wherein the desired power output is based on an operating condition of the electric drive system; determine a state of charge of each energy storage module of the set of energy storage modules; and determine a power setpoint to be provided by the power conversion system based on the desired power output and the state of charge of the set of energy storage modules.

In some variations, the power controller is configured to determine a virtual resistance based on the state of charge of the set of energy storage modules, where the power setpoint is further determined based on the virtual resistance.

In some variations, the power controller is configured to determine an estimated state of charge of each energy storage module in response to the drive power output being applied to the electric drive system, where a subsequent power setpoint is determined based on the estimated state of charge.

In some variations, a system includes an electric drive system including an electric motor, and the electric power system, where the one or more power conversion systems is provided for each phase of the electric motor.

In one form, the present disclosure is directed to an electric power system for a vehicle, where the vehicle includes a power bus, an energy storage pack, and an electric drive system. The electric power system includes one or more power conversion systems electrically connected in parallel for each phase of an electric motor of the electric drive system. Each power conversion system is electrically coupled to a set of energy storage modules from among a plurality of energy storage modules of the energy storage pack. Each power conversion system includes a plurality of sub-system modules electrically coupled to provide a drive power output to the electrical drive system and an auxiliary power output to the power bus. Each sub-system module includes a power circuit and a power controller. The power circuit is electrically coupled to a subset of energy storage modules and configured to provide a proportional drive power output and a proportional auxiliary power output to the power bus, where the subset of energy storage modules are selected from among the set of energy storage modules. The power controller is configured to control the power circuit to provide the proportional drive power output based on desired power output of the electric drive system. The proportional drive power outputs from the plurality of sub-system modules are provided as the drive power output, and the proportional auxiliary power output from the plurality of sub-system modules are provided as the auxiliary power output.

In some variations, the power controller for a sub-system module is configured to: obtain a power setpoint for respective power conversion system, wherein the power setpoint is based on the desired power output of the electric drive system, and determine the proportional drive power output to be provided to the electric drive system by the power circuit based on the power setpoint and a state of charge of the subset of energy storage modules.

In one form, the present disclosure is directed to a method for providing power to a vehicular electric drive system employing an electric power system. The method includes obtaining a desired power output of the electric power system, where the electric power system includes one or more power conversion systems, each power conversion system is electrically coupled to a set of energy storage modules from among a plurality of energy storage modules. For each power conversion system, the method further includes obtaining a state of charge of each energy storage module of the set of energy storage modules, and determining a power setpoint to be provided by the power conversion system based on the desired power output and the state of charge of the set of energy storage modules.

The following includes variations of the method for providing power to a vehicular electric drive system employing an electric power system, which may be implemented individually or in any combination.

In some variations, the method further includes, for each power conversion system, determining a virtual resistance based on the state of charge of the set of energy storage modules, wherein the power setpoint is further determined based on the virtual resistance.

In some variations, the method further includes providing power to the vehicular electric drive system by the electric power system based on the power setpoint, and determining an estimated state of charge of each energy storage module in response to providing power to the vehicular electric drive system, where a subsequent power setpoint is determined based on the estimated state of charge.

In some variations, the method further includes, for each power conversion system measuring a voltage applied to the vehicular electric drive system; and determining an estimated state of charge of the set of energy storage modules based on the voltage applied and the power setpoint, wherein a subsequent power setpoint is determined based on the estimated state of charge.

In some variations, each power conversion system includes a plurality of sub-system modules electrically coupled to a subset of energy storage modules among the set of energy storage modules. The method further includes obtaining, by each sub-system module, the power setpoint for the respective power conversion system. and determining, by each sub-system module of the respective power conversion system, a proportional drive power output to be provided to the vehicular electric drive system by the sub-system module based on the power setpoint and a state of charge of the subset of energy storage modules electrically coupled to the sub-system module.

In some variations, the method further includes, by each sub-system module among the plurality of sub-system modules, measuring an applied current to the vehicular electric drive system in response to applying the proportional drive power output, and determining an estimated state of charge of the subset of energy storage modules based on the applied current and a peak charge capacity of the subset of the energy storage modules, where a subsequent proportional drive power output is determined based on the estimated state of charge of the subset of energy storage modules.

In some variations, each power conversion system includes a plurality of sub-system modules electrically coupled to a subset of energy storage modules among the set of energy storage modules. The method further includes obtaining a state of charge of the subset of energy storage modules from each sub-system module from among the plurality of sub-system modules, determining a desired operation order of the sub-system modules based on the state of charge obtained, selecting one or more sub-system modules from among the plurality of sub-system modules, as power output modules, based on the desired operation order and the power setpoint, determining, for each power output module, a proportional drive power setpoint to be provided to the vehicular electric drive system based on the power setpoint, and providing the proportional drive power setpoint to the respective power output sub-system module.

In some variations, the method further includes assigning a status to each power output module based on load demands and a state of the subset of energy storage modules, wherein the status is selected from among actively ON and actively switching ON-OFF.

In some variations, the method further includes having a first set of power output modules provided with a status of actively ON during a selected time period while a second set of power output modules different from the first set of power output module is provided with a status of actively switching ON-OFF during the selected time period.

In some variations, each of the first set of power output modules and the second set of power output modules includes at least one power output module.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a block diagram of a vehicle having an electric power system in accordance with the present disclosure;

FIGS. 2A, 2B, and 2C illustrate wiring configuration of the electric power system having a plurality of power conversion systems with an electric motor of an electric drive system in accordance with the present disclosure;

FIG. 3 is a block diagram of the power conversion system in accordance with the present disclosure;

FIG. 4 illustrates an example power circuit of the power conversion system in accordance with the present disclosure;

FIG. 5 illustrates another form a power conversion system having a plurality of sub-system modules in accordance with the present disclosure;

FIG. 6 is a block diagram of the sub-system module in accordance with the present disclosure;

FIG. 7 is an example power circuit of a sub-system module in accordance with the present disclosure;

FIG. 8 is a flowchart of an example control routine for a power conversion system in accordance with the present disclosure;

FIGS. 9A and 9B are flowcharts of example control routines for a power conversion system having multiple subsystem modules in accordance with the present disclosure; and

FIG. 10 is a flowchart of another example of control routine for a power conversion system having multiple subsystem modules in accordance with the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present disclosure provides an electric power system for having a modular power conversion structure to provide a drive power output to an electric drive system of a vehicle and an auxiliary power output to one or more power busses. In one form, the electric power system includes one or more power conversion system (PCS) having a power circuit and a power controller. As described herein, multiple PCSs can be coupled in series and/or parallel to provide power to the electric drive system and the power bus(es), thereby providing modular and/or scalable hardware design with distributed software control.

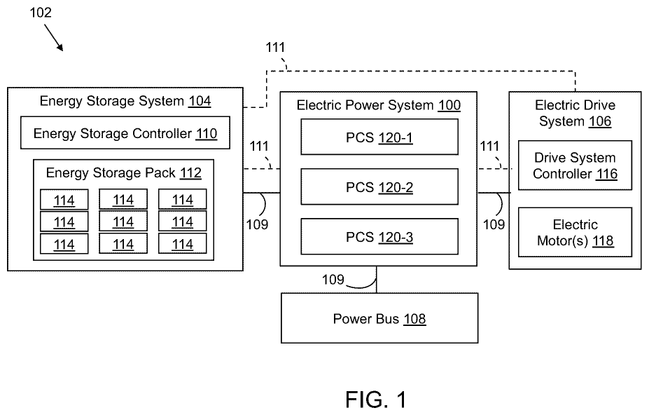

Referring to FIG. 1, among other components, an electric power system 100 of the present disclosures is provided in a vehicle 102. Among other components, the vehicle 102 includes an energy storage system 104, the electric power system 100, an electric drive system 106, and a power bus 108. For illustration purposes only, the solid line 109 is provided to illustrate a power line and a dashed line 111 is provided to illustrate a communication link. The power lines 109 are not intended to illustrate the actual physical circuit (e.g., wires, ports, circuitry) nor should be interpreted to mean same power is provided, as is clear in the description below. With respect to the communication links 111, it should be readily understood that systems within the vehicle 102 including the energy storage system, electric, electric power system 100, and the electric drive system 106 may be communicably coupled in various suitable ways such as wireless communication and/or wired communication.

The energy storage system 104 includes an energy storage controller 110, an energy storage pack 112 having a plurality of energy storage modules 114. The energy storage controller 110 is configured to monitor operation characteristics of the energy storage pack 112 such as, but not limited to, the state of charge of the energy storage pack 112 and each of the energy storage modules 114, and a temperature of the energy storage pack 112. In one form, the energy storage pack 112 may be provided as a battery pack having a plurality of battery modules/cells, as the energy storage modules 114, for providing power to the electric power system 100.

The electric drive system 106 is configured to drive the vehicle in one or more directions and includes, among other components, a drive system controller 116 and one or more electronic motors 118. The drive system controller 116 is configured to monitor performance of the electric motor(s) 118 and for determining a desired power output to for the motor(s) 118 based on one or more operating conditions such as, but not limited to, motor speed, torque, and safety conditions. The drive system controller 116 can be configured in various suitable ways such as one controller can be provided for each motor 118 or one controller can be configured to control more than one or all the motors 118. The electric motor(s) 118 may be single or multi-phase electric motors.

The power bus 108 is generally configured to provide direct current (DC) power to other electric devices in the vehicle 102 such as, but not limited to, heat pump, electric powered steering (EPS) pump, auxiliary outlets, and/or fans. In some variations, the vehicle may include multiple power buses 108 that are configured to provide the same and/or different DC power. For example, one power bus 108 may provide a 12V DC and another power bus may provide 24V DC.

The electric power system 100 of the present disclosure is configured to provide a drive power output to the electric drive system 106 and an auxiliary power output to the power bus 108. In one form, the electric power system 100 include a plurality of power conversion systems (PCS) 120-1, 120-2, 120-3 for providing power to the electric drive system 106 and the power bus 108. The PCSs 120-1, 120-2, 120-3 are collectively referred to as PCSs 120, and while three PCSs 120 are illustrated, the electric power system 100 may include one or more PCSs 120 and should not be limited to three. In one form, the number of PCS 120 may be based on the design and/or demands of the electric drive system 106 and/the power bus(es) 108.

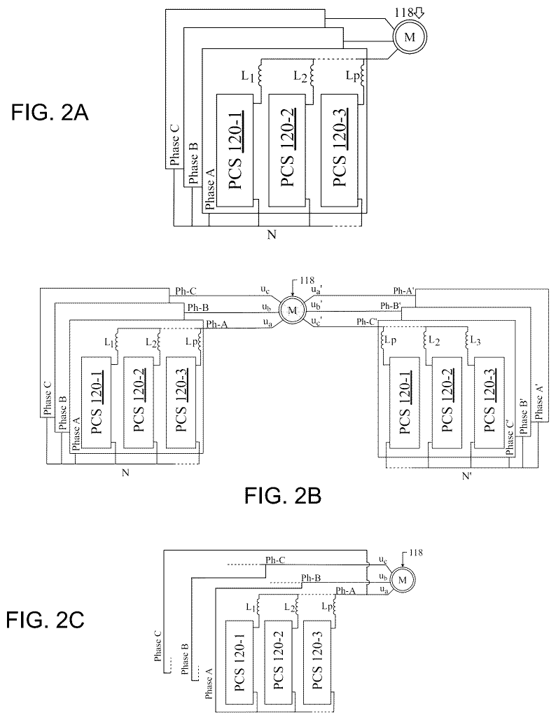

With respect to the electric drive system 106, “P” number of PCSs 120 are connected in parallel to provide power to the same motor 118 or, in another variation, an “X” number of motors 118, where “X” is a number greater than or equal to one. For example, referring to FIGS. 2A to 2C different wiring configurations are provided to illustrate the various applications the electric power system 100 can be employed for. FIG. 2A, illustrates a multiphase motor as the motor 118, where the electric power system 100 having the PCSs 120 is provided at phase A. The PCSs 120 are connected in parallel to operate the electric motor 118 with a single star configuration\. FIG. 2B illustrates a double star configuration having two electric power systems 100A and 100B each having the plurality of the PCSs 120 connected in parallel to operate the electric motor 118. FIG. 2C illustrates the electric power system 100 having the PCSs 120 connected in parallel to operate the electric motor 118 in a single delta configuration. In FIGS. 2A, 2B, 2C,″ N is neutral; L1, L2, L3 are inductors, which are optional, connected between the output of each PCS 120 and a terminal of the motor 118 to reduce the circulating current between the PCSs 120; and uₐ, u_{b}, u_{c} denotes voltage. It should be readily understood that for a multiphase motor, each phase may include the electric power system 100 of the present disclosure, or in other words, each phase may include one or more PCSs 120. The number of PCSs can differ from one phase to the other.

In one form, each PCS 120 is electrically coupled to a set of energy storage modules 114 from among the plurality of energy storage modules 114 of the energy storage pack 112. For example, referring to FIG. 1, a PCS 120 is electrically coupled to, as the set of energy storage modules, a row of energy storage modules 114. As provided herein, the electric power system 100 of the present disclosure may work with various power levels (e.g., voltage) for the energy storage modules 114. Here, the term “set” for energy storage modules may include one or more energy storage modules 114.

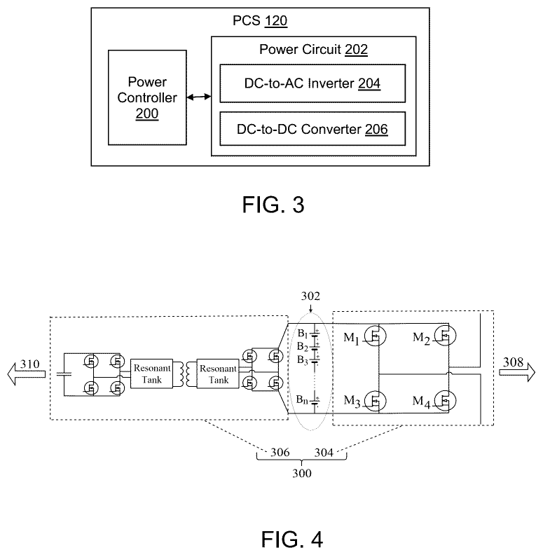

In one form, referring to FIG. 3, each PCS 120 includes a power controller 200 and a power circuit 202. As described further herein, the power controller 200 is configured to determine amount of power to be provided by the PCS 120 based on the desired power output and control the power circuit 202 to provide the drive power output to the electric drive system 106. The power controller 200 may include various hardware and/or software components for performing operations as described herein, such as, but not limited to: processor for executing software programs, switch drivers to operate power electronic switches, and communication ports for receiving and/or transmitting data to other controllers.

The power circuit 202 is electrically coupled to the set of energy storage modules 114 and configured to provide the drive power output to the electric motor 118 and an auxiliary power output to the power bus 108. More particularly, in one form, the power circuit 202 includes a direct current-to-alternating current (DC-to-C) inverter 204 configured to provide the drive power output and a direct current-to-direct current (DC-to-DC) converter 206 configured to provide the auxiliary power output. The DC-to-AC inverter 204 and DC-to-DC converter 206 are electrically isolated from each other. Specifically, at least one of the DC-to-AC inverter 204 and DC-to-DC converter 206 includes an electric isolation circuit to inhibit shoot through faults across converter terminals. In an example application, the power circuit 202 may include a magnetic isolation at the DC-to-DC converter 206 and/or other suitable electric isolation circuitry such as, but not limited to inductive or capacitive isolation to separate the primary and secondary sides of the converter.

In some applications, the DC-to-DC converters of the power circuits of the plurality of conversion systems may be electrically coupled to provide respective auxiliary power outputs to the power bus. For example. the DC-to-DC converters of the power circuits 202 of at least two PCS 120 from among the plurality of PCS 120 are electrically coupled in series or in parallel to provide respective auxiliary power outputs to the power bus 108. Accordingly, 48V may be provided to the power bus 108 by electrically coupling two 12V generating DC-to-DC converters in series. In addition, if the vehicle 102 includes multiple power buses 108, the DC-to-DC converters 206 of the power conversion systems can be assigned to different power busses 108. For example, the DC-to-DC converters 206 of two PCSs 120 are electrically coupled to provide respective auxiliary power outputs to a first power bus 108 and the DC-to-DC converter 206 of a third PCS 120 is configured provide respective auxiliary power output to a second power bus 108. In yet another example, the DC-to-DC converter 206 of a first PCS 120 is configured to provide respective auxiliary power output to a first power bus 108 and the DC-to-DC converter 206 of a second PCS 120 is configured to provide respective auxiliary power output to a second power bus 108. Accordingly, the electric power system 100 of the present disclosure can be configured in various suitable ways to provide power to one or more power buses 108 of the vehicle 102.

Referring to FIG. 4, a power circuit 300 connected to a set of energy storage modules 302 is provided and can be employed as the power circuit 202 and the energy storage modules 114, respectively. The power circuit 300 may be described as having a string of converters comprising a DC-to-AC inverter 304 supplying a drive power output to the electric drive system 106, and a DC-to-DC converter 306 supplying an auxiliary power output to the power bus 108. The DC-to-AC inverter 304 and the DC-to-DC converter 306 may be used as the DC-to-AC inverter 204 and the DC-to-DC converter 206. The drive power output is illustrated as arrow 308 and the auxiliary power output is illustrated as arrow 310.

In one form, the DC-to-AC inverter 304 is provided as a three level inverter having power electronics composed of power electronic switches which could be metal-oxide semiconductor field-effect transistor (MOSFET), insulated-gate bipolar transistor (IGBT), thyristor or gate turn-off thyristor (GTO). The power electronic switches are operable by the power controller 200 to generate the desired drive power output. In one form, the DC-to-AC inverter 304 is provided as a bidirectional inverter, where the output terminals connect to one another in series and parallel configurations to provide power to the electric motor 118. It should be readily understood that the DC-to-AC inverter 304 may include additional and/or other components and should not be limited to the circuit configuration provided illustrated in FIG. 4. For example, the DC-to-AC inverter 304 may include filters and/or components to isolate the inverter 304 from the DC-to-DC converter 306.

The DC-to-DC converter 306 is provided as an isolated converter having electronics such as, but not limited to, a flyback converter, half-bridge circuit, full-bridge circuit, and/or inductors and capacitor. In FIG. 4, the DC-to-DC converter 306 provides regulated DC output at 12V or 48V levels. However, as provided above, the DC-to-DC converter 306 can be configured in various suitable ways to individually or in association with other DC-to-DC converters 306 provide auxiliary power output(s) to one or more power buses 108, and should not be limited to the configuration illustrated in the figures. In one form, the DC-to-DC converter 306 is a bidirectional converter. It should be readily understood that the DC-to-DC converter 306 may include additional and/or other components and should not be limited to the should not be limited to the circuit configuration provided illustrated in FIG. 4. For example, the DC-to-DC converter 306 may include filters, and/or may not include components to isolate the converter 306 from the DC-to-AC inverter 304.

In one form, the number of energy storage modules 114 contributing to power to the power bus 108 may be directly proportional to the relative power consumption of that the power bus 108 in comparison to the full power consumption of all power buses 108. Accordingly, an energy storage module 114 from among the plurality of energy storage modules can be contributing power to none, one or more of the power buses 108.

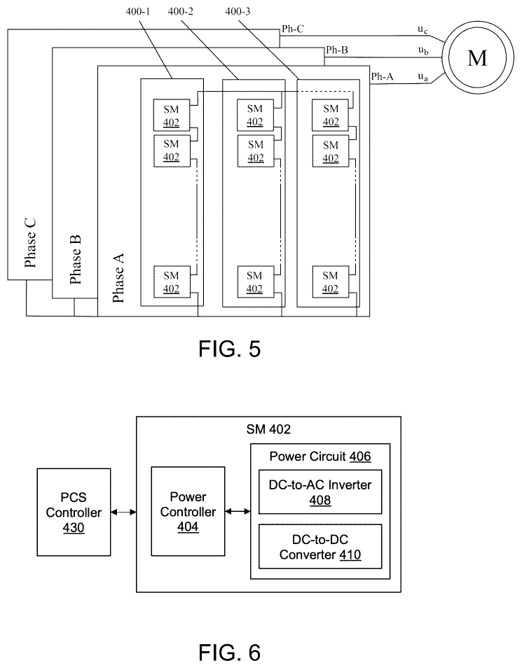

Each PCS 120 of FIG. 3 includes a three level DC-to-AC inverter for generating the drive power output to the electric drive system 106. Referring to FIGS. 5 and 6, in another form, the electric power system 100 of the present disclosure may include a plurality of PCSs 400-1, 400-2, and 400-3 (collectively as “PCSs 400”) connected in parallel to the same phase, and each having a multilevel modular converter configuration. More particularly, each PCS 400 includes a plurality of sub-system modules (SM) 402, where each SM 402 includes a power controller 404 and a power circuit 406. Stated in a different way, each SM 402 may be considered a PCS 120, and the plurality of PCS 120 are connected in series forming a string of conversion systems 120. While multiples PCSs 400 are illustrated, the number of PCSs 400 can be one or more, and the number of SMs 402 per PCS 400 can be two or more. In addition, if there are multiple PCSs 400, the number of SMs 402 may be the same or different among the PCSs 400. In one form, the number of PCS 400 and number of SMs 402 for a selected PCS 400 may be based on the design and/or demands of the electric drive system 106 and/the power bus(es) 108.

Similar to the power circuit 202, the power circuit 406 of the SM 402 includes a DC-to-AC inverter 408 and a DC-to-DC converter 410. The power circuit 406 of the SM 402 is configured to provide a proportional drive power output and a proportional auxiliary power output. The proportional drive power outputs from the power circuits of the plurality of SMs 402 are provided as the drive power output from the respective PCS 400 and the proportional auxiliary power outputs from the power circuits 406 of the plurality of SMs 402 are provided as the auxiliary power output from the respective PCS 400.

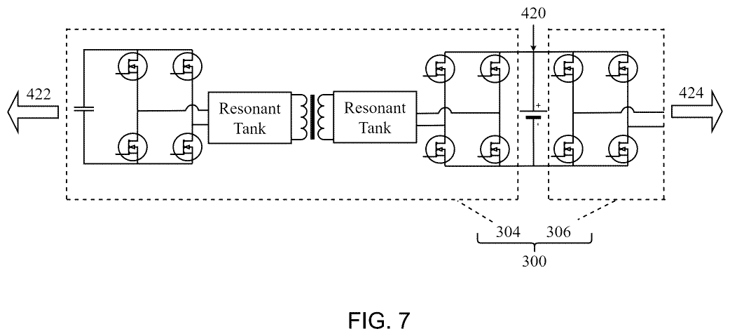

Similar to the PCS 120, each PCS 400 is electrically coupled to a set of energy storage modules 114 from among the plurality of energy storage modules 114 of the energy storage pack 112. Each SM 402 is electrically coupled to a subset of energy storage modules 114 from among the set of energy storage modules. More particularly, referring to FIG. 7, the power circuit 406 for the SM 402 may be implemented using the power circuit 300, but is electrically coupled to a subset of energy storage modules 114 generally identified by reference number 420. That is, the DC-to-AC inverter 408 may be implemented with the DC-to-AC inverter 304, where the DC-to-AC inverters 408,304 of the PCS 400 are electrically coupled to each other in series and/or parallel. The DC-to-DC converter 410 may be implemented with the DC-to-DC converter 306, where the DC-to-DC converters 410 of the PCS 400 are electrically coupled to each other in series and/or parallel. For the PCS 400 configuration, the DC-to-DC converter 306 outputs a proportional auxiliary power output identified by arrow 422 and the DC-to-AC inverter outputs a proportional drive power output identified by arrow 424. A subset of energy storage modules may include one or more energy storage modules/cells.

Similar to the PCSs 120, the PCSs 400 may be wired such that the auxiliary power output from a PCS 400 is provided to a single power bus 108 or is electrically coupled to terminals of one or more other PCSs 400 (e.g., terminals are connected in parallel and/or series) to provide respective auxiliary power outputs to one or more power buses 108.

The PCSs 400 provide a scalable and modular multilevel power system configuration to regulate both, the drive power output to the electric drive system 106 (e.g., to one or more electric motors) and the auxiliary power output to one or more power buses 108. That is, the PCSs 400 is designed to generate multiple DC and AC power outputs using distributed DC-to-DC converters 410 and DC-to-AC inverters 408.

In the variations described herein, the electric power system 100 may include one-level or two-level of control. For example, a first level may be a power conversion control and an optional second level may be a submodule control. The power conversion control may include multiple controllers, where each controller controls a given PCS 120,400. For example, with regard to the PCSs 120, the power controllers 200 may form the power conversion control for the electric power system 100. The optional sub-module control is employed with the sub-system module configuration of the PCSs 400, and the number of module controllers may be equal to the number of SMs 402. For example, the power controllers 404 may form the second level sub-module control. For the electric power system 100 having the PCSs 400, the first level control may be provided as a controller for each PCS 400. For example, FIG. 6 illustrates a PCS controller 430 that is communicably coupled to the SM 402. In one form, each PCSs 400 includes a dedicated PCS controller 430 for communicating with each power controller 404 of the SM 402 of the PCS 400, thereby forming two-level control. In another form, the operation of the power controllers 404 of the multiple SMs 402 is implemented in the PCS controller 430, thereby removing a dedicated power controller 404 for the SM 402 and providing a single level control of the PCS 400.

In an example implementation, the drive system controller 116 of the electric drive system 106 is configured to obtain one or more operating conditions of the motor 118 and determines a desired power output of the electric drive system 106, that is provided to the electric power system 100. For example, the drive system controller 116 receives a desired motor speed and based on the desired speed, determines a speed error that is provided to a closed-loop control such as, but not limited to, a proportional integral (PI) control and/or a predictive model control. Based on the closed-loop control, the drive system controller 116 is configured to determine a desired torque and using other control models determines a reference current to flow in the electric motor and/or a reference voltage to be applied to the electric motor. The reference voltage may be represented in a DQ rotating reference frame which indicates the magnitude of the reference AC signal that has the same frequency and phase as the back EMF (Q-components) and the magnitude of another AC voltage (D-components) which has 90 degrees phase shift from the Q component to generate the reference AC voltage. The Q and D components, as desired power output, can be employed for single-and multi-phase systems. The Q and D components can be the resultant rotating vector of a three phase while the D vector are axis that can be generated from three phase with 90 degrees phase shift from the components that produce the Q vector. The value of Q and D components may be provided to the electric power system 100 as desired power output. The reference current and/or the reference voltage are also examples of desired power output.

The above-described example of how the drive system controller 116 determines a desired power output based on operating condition is just one example using one condition (e.g., motor speed). It should be readily understood that the drive system controller 116 typically employs a complex control scheme for determining desired power output based on multiple variables and operating conditions. The electric power system 100 of the present disclosure can be employed with such drive systems controller 116 for providing the requisite power to the electric motor 118.

With regard to the PCSs 120, each PCSs 120 receives the desired power output for the electric motor 118 and the power controller 200 of the

PCS 120 is configured to determine a power setpoint to be provided by the PCS 120 based on the desired power output and a state of charge (SOC or SoC) of the set of energy storage modules 114. For example, the power controller 200 may receive the value of Q and D voltage, as the desired power output, and the power controller 200 estimates or calculates the SOC of the set of energy storage modules 114 electrically coupled to the power circuit 202. In one form, the power controller 202 determines the power setpoint for the i-th PCS 120 as an output voltage (Vₒᵤₜⁱ) determined using equation (1).

$$\\ \begin{matrix}{V}_{out}^{{}_{} i} = ( {V}_{q} - ( {K}_{s} / {K}_{BS} + {SOC}^{{}_{} i} ) {i}_{q}^{{}_{} i} ) cos {ϕ}_{S} + ( {V}_{d} - ( {K}_{s} / {K}_{BS} + {SOC}^{{}_{} i} ) {i}_{d}^{{}_{} i} ) sin {ϕ}_{S} & ( 1 )\end{matrix}$$

In equation (1), V_{q} is Q components of the desired power output; V_{d} is the D component of the desired power output; i_{q}ⁱ is component of DC-to-AC inverter current in phase with back EMF measured in a previous control cycle; i_{d}ⁱ is component of DC-to-AC inverter current in with 90 degrees phase shift from the back EMF measured in the previous control cycle; SoCⁱ is an equivalent SOC level of the set of energy storage modules 114 associated with the i-th PCS; cosϕ_{S} is the cosine phase of the back EMF; sin ϕ_{S} is the sine phase of the back EMF; K_{S} is a global constant used across all PCSs 120; and K_{BS} is a global stabilizing constant used across all PCSs 120. At steady state, the PCSs 120 apply the same value V_{q}−k/SoCⁱ i_{q}ⁱ and V_{d}−k/SoCⁱ i_{d}ⁱ such that the current flowing from the PCSs 120 to the electric motor 118 maintains the same magnitude and phase. Accordingly, x^{th} and y^{th} PCSs 120 apply the relation provided in (2) below. The same relation applies to i_{d}^{x} and i_{d}^{y} which indicates that each PCS supplies an amount of power proportional to its SOC which provide for SOC equalization among energy storage modules of the PCSs 120.

$$\\ \begin{matrix}{V}_{q} - \frac{k}{{SoC}^{{}_{} x}} {i}_{q}^{{}_{} x} = {V}_{q} - \frac{k}{{SoC}^{{}_{} y}} {i}_{q}^{{}_{} y} \to \frac{{i}_{q}^{{}_{} x}}{{SoC}^{{}_{} x}} = \frac{{i}_{q}^{{}_{} y}}{{SoC}^{{}_{} y}} \to \frac{{i}_{q}^{{}_{} x}}{{i}_{q}^{{}_{} y}} = \frac{{SoC}^{{}_{} x}}{{SoC}^{{}_{} y}} & ( 2 )\end{matrix}$$

A similar control scheme can also be provided for the electric power system 100 having at least one PCSs 400. In particular, each SM 402 is connected to a sub-set of energy storage modules 114, and is controlled by the power controller 404 or if there is no power controller 404, by the PCS controller 430 having the SM 402. In a first application in which the SM 402 includes the power controller 404, the power controllers 404 are configured to obtain a power setpoint for the PCS 400. The power setpoint can be provided by PCS controller 430.

In an example application, the power setpoint is provided as a reference current to be provided by the PCSs 400. The SM module 402, and more particularly, the power controller 404 is configured to determine a proportional drive power as a current output (Iₒᵤₜ^{j}) using equation (3), where “j” identifies the SM module 402 from among the plurality of SM modules (i.e., the j-th SM module out of J total SM modules for the ith-PCS 400). In equation (3), I_{q}ⁱ is the Q components specified by the PCS 400; I_{d}ⁱ is the D components specified by the ith-PCS 400; v_{q}ⁱ is the component of a modular converter voltage in phase with the electric current of the PCS 400 measured in previous control cycle; v_{d}^{j} is the component of the modular converter voltage with 90 degrees phase shift from the electric current of the PCS 400 measured in the previous control cycle; SoC^{j} is the equivalent SOC level of the subset of energy storage modules associated with the j^{th} SM 402; cos ϕ_{M} is the cosine phase of the electric current; sin ϕ_{M} is the sine phase of the electric current; k_{M} is a global constant used across all the SMs 402 in the i^{th} PCS; and KBM is a global stabilizing constant used across all the SMs 402 in the i^{th} PCS.

$$\\ \begin{matrix}{I}_{out}^{{}_{} j} = ( {I}_{q}^{{}_{} i} - ( {K}_{m} / {K}_{BM} + {SOC}^{{}_{} j} ) {v}_{q}^{{}_{} j} ) cos ϕ + ( {I}_{d}^{{}_{} i} - ( {K}_{m} / {K}_{BM} + {SOC}^{{}_{} j} ) {v}_{d}^{{}_{} j} ) sin ϕ & ( 3 )\end{matrix}$$

At steady state, all SM 402 apply the same value as provided in (4) below.

$$\\ \begin{matrix}{I}_{q}^{{}_{} i} - ( {K}_{m} / {K}_{BM} + {SOC}^{{}_{} j} ) {v}_{q}^{{}_{} j} and {I}_{d}^{{}_{} i} - ( {K}_{m} / {K}_{BM} + {SOC}^{{}_{} j} ) {v}_{d}^{{}_{} j} & ( 4 )\end{matrix}$$

Accordingly, the x^{th} and y^{th} SM 402 apply the relation in (5) which leads to the relationship in (6). The same relation applies to v_{d}^{x} and v_{d}^{y}, indicating that each SM 402 supplies and an amount of power proportional to its SOC level, leading to SOC equalization among the energy storage modules 114 using the load power.

$$\\ \begin{matrix}{I}_{q}^{{}_{} i} - ( {K}_{M} / {SOC}^{{}_{} x} ) {v}_{q}^{{}_{} x} = {I}_{q}^{{}_{} i} - ( {K}_{M} / {SOC}^{{}_{} Y} ) {v}_{q}^{{}_{} Y} & ( 5 )\end{matrix}$$

$$\\ \begin{matrix}\frac{{v}_{q}^{{}_{} x}}{{SOC}^{{}_{} x}} = \frac{{v}_{q}^{{}_{} y}}{{SOC}^{{}_{} y}} \to \frac{{v}_{q}^{{}_{} x}}{{v}_{q}^{{}_{} y}} = \frac{{SOC}^{{}_{} x}}{{SOC}^{{}_{} y}} & ( 6 )\end{matrix}$$

In a second approach, the desired power output is provided as reference voltage (V_{ref}) and is sent to the PCSs 400. The PCS controller 430 is configured to determine the power setpoint for the PCS 400 as a reference voltage output (Vₒᵤₜⁱ), using (1) above, where “k” represents the PCS 400 from among the plurality of PCSs 400 (e.g., kth PCS out of total number of PCSs).

The k^{th} PCS controller 430 uses an estimate for the equivalent SoC (SoC^{k}) of the SM 402 connected to it and the number of SMs 402 in the PCS (N^{k}) to determine the voltage (V_{T}^{k}) which is given by (7) below.

$$\\ \begin{matrix}{V}_{T}^{{}_{} k} = {V}_{out}^{{}_{} k} \frac{1}{{SoC}^{{}_{} k} {N}^{{}_{} k}} & ( 7 )\end{matrix}$$

The k^{th} PCS controller 430 provides (V_{T}^{k}) to the SMs as a power setpoint to be provided by the PCS 400. The m^{th} SM 402 (m=1, 2, . . . . N^{k}) receives the voltage V_{T}^{k} and determines the proportional drive power output as a voltage Vₘⁱ defined by (8) below, where SoCₘ^{k} is the SOC of the subset of energy storage module of the m^{th} SM 402.

$$\\ \begin{matrix}{V}_{m}^{{}_{} k} = {V}_{T}^{{}_{} k} {SoC}_{m}^{{}_{} k} & ( 8 )\end{matrix}$$

Accordingly, the voltage (Vₐₚₚ^{k}) at the terminals of the k^{th} PCS is provided by (9), and is further represented by (10) since

$$\\ {V}_{T}^{{}_{} k} = {V}_{out}^{{}_{} k} \frac{1}{{N}^{{}_{} k} {SoC}^{{}_{} k}} .$$

$$\\ \begin{matrix}{V}_{app}^{{}_{} k} = {\sum }_{m = 1}^{{N}^{{}_{} k}} {V}_{m}^{{}_{} k} = {\sum }_{m = 1}^{{N}^{{}_{} k}} {V}_{T}^{{}_{} k} {SoC}_{m}^{{}_{} k} = {V}_{T}^{{}_{} k} {\sum }_{m = 1}^{{N}^{{}_{} k}} {SoC}_{m}^{{}_{} k} & ( 9 )\end{matrix}$$

$$\\ \begin{matrix}{V}_{app}^{{}_{} k} = {V}_{T}^{{}_{} k} {\sum }_{m = 1}^{{N}^{{}_{} k}} {SoC}_{m}^{{}_{} k} = {V}_{out}^{{}_{} k} \frac{1}{{SoC}^{{}_{} k} {N}^{{}_{} k}} {\sum }_{m = 1}^{{N}^{{}_{} k}} {SoC}_{m}^{{}_{} i} = {V}_{out}^{{}_{} k} \frac{1}{{SoC}^{{}_{} k}} \frac{{\sum }_{m = 1}^{{N}^{{}_{} k}} {SoC}_{m}^{{}_{} k}}{{N}^{{}_{} k}} & ( 10 )\end{matrix}$$

The PCS controller uses Σₘ₌₁^{N}^{^{k}} SoCₘⁱ/N^{k} as an estimate for SoC^{k} by using the relation

$$\\ {SoC}^{{}_{} k} = \frac{{V}_{app}^{{}_{} k}}{{V}_{T}^{{}_{} k} {N}^{{}_{} k}} .$$

Since SOC changes very slowly, the used estimate for SoC^{k} in every cycle is provided as the measured

$$\\ \frac{{\sum }_{m = 1}^{{N}^{{}_{} k}} {SoC}_{m}^{{}_{} k}}{{N}^{{}_{} k}}$$

by the SM 402 in the following cycle. Accordingly, power output of the PCS 400 is provided as (11).

$$\\ \begin{matrix}{V}_{app}^{{}_{} k} = {V}_{out}^{{}_{} k} \frac{1}{{SoC}^{{}_{} k}} \frac{{\sum }_{m = 1}^{{N}^{{}_{} k}} {SoC}_{m}^{{}_{} k}}{{N}^{{}_{} k}} = {V}_{out}^{{}_{} k} & ( 11 )\end{matrix}$$

The power ratio between the m^{th} and n^{th} of the k^{th} PCS is given by (12) where i^{k} is the current that passes over the PCS 400, which follows the required proportion of the corresponding SoC.

$$\\ \begin{matrix}\frac{{P}_{m}^{{}_{} k}}{{P}_{n}^{{}_{} k}} = \frac{{i}^{{}_{} k} {V}_{m}^{{}_{} k}}{{i}^{{}_{} k} {V}_{n}^{{}_{} k}} = \frac{{i}^{{}_{} k} {V}_{T}^{{}_{} k} {SoC}_{m}^{{}_{} k}}{{i}^{{}_{} k} {V}_{T}^{{}_{} k} {SoC}_{n}^{{}_{} k}} = \frac{{SoC}_{m}^{{}_{} k}}{{SoC}_{n}^{{}_{} k}} & ( 12 )\end{matrix}$$

The ratio of Pₙ^{k} and the total PCS power P^{k} is given by (13)

$$\\ \begin{matrix}{P}^{{}_{} k} = {\sum }_{m = 1}^{{N}^{{}_{} k}} {P}_{m}^{{}_{} k} = {\sum }_{m = 1}^{{N}^{{}_{} k}} {P}_{n}^{{}_{} k} \frac{{SoC}_{m}^{{}_{} k}}{{SoC}_{n}^{{}_{} k}} = \frac{{P}_{n}^{{}_{} k}}{{SoC}_{n}^{{}_{} k}} {\sum }_{m = 1}^{{N}^{{}_{} k}} {SoC}_{m}^{{}_{} k} = \frac{{P}_{n}^{{}_{} k}}{{SoC}_{n}^{{}_{} k}} {N}^{{}_{} k} {SoC}^{{}_{} k} & ( 13 )\end{matrix}$$

Similarly, for a^{th} SM 402 of b^{th} PCS 400,

$$\\ {P}^{{}_{} b} = \frac{{P}_{a}^{{}_{} b}}{{SoC}_{a}^{{}_{} b}} {N}^{{}_{} b} {SoC}^{{}_{} b} .$$

Accordingly, relationships (14), which is based on (2), and (15) can be provided.

$$\\ \begin{matrix}\frac{{P}^{{}_{} b}}{{P}^{{}_{} k}} = \frac{{SoC}^{{}_{} b}}{{SoC}^{{}_{} k}} & ( 14 )\end{matrix}$$

$$\\ \begin{matrix}\frac{\frac{{P}_{a}^{{}_{} b}}{{SoC}_{a}^{{}_{} b}} {N}^{{}_{} b} {SoC}^{{}_{} b}}{\frac{{P}_{n}^{{}_{} k}}{{SoC}_{n}^{{}_{} k}} {N}^{{}_{} k} {SoC}^{{}_{} k}} = \frac{{SoC}^{{}_{} k}}{{SoC}^{{}_{} b}} \to \frac{{P}_{a}^{{}_{} b}}{{P}_{n}^{{}_{} k}} = \frac{{SoC}_{a}^{{}_{} b} / {N}^{{}_{} k}}{{SoC}_{a}^{{}_{} k} / {N}^{{}_{} b}} = \frac{{SoC}_{a}^{{}_{} b}}{{SoC}_{a}^{{}_{} k}} \frac{{N}^{{}_{} k}}{{N}^{{}_{} b}} & ( 15 )\end{matrix}$$

The ratio between the power supplied by SMs 402 in different PCSs 400 is proportional to the ratio of their SoC. If the PCSs 400 have the same number of SMs 402,

$$\\ \frac{{N}^{{}_{} k}}{{N}^{{}_{} b}} = 1$$

and the power ratios follows the ratio between the corresponding SoC. Otherwise, the value of Kₛ for the virtual resistances of the PCSs 400 can be adjusted to accommodate for the different number of SMs 402 per PCS 400.

The PCS controller is configured to adjust V_{ref}^{k} until Vₒᵤₜ matches V_{ref} at steady state. Since the same current (i^{k}) passes over all SMs 402, the power sharing between x^{th} and y^{th} SMs 402 of the k^{th} PCS 400 are related to each other by the following relation (16):

$$\\ \begin{matrix}\frac{{P}_{x}^{{}_{} k}}{{P}_{y}^{{}_{} k}} = \frac{{i}^{{}_{} k} {V}_{x}^{{}_{} k}}{{i}^{{}_{} k} {V}_{y}^{{}_{} k}} = \frac{{V}_{ref}^{{}_{} k} \times {SoC}_{x}^{{}_{} k}}{{V}_{ref}^{{}_{} k} \times {SoC}_{y}^{{}_{} k}} = \frac{{SoC}_{x}^{{}_{} k}}{{SoC}_{y}^{{}_{} k}} & ( 16 )\end{matrix}$$

Based on the foregoing control schemes for the electric power system 100 having PCSs 400, the drive system controller 116 provides a desired power output (e.g., a reference voltage or a reference current) to the PCS controller 430, which in return determines the power setpoint for the PCS 400 based on the SOC of the set of energy storage modules 114 coupled to the PCS 400, and provides the power setpoint to the power controllers 404 of the SMs 402. The power controller 404 for a selected SM 402 determines the proportional drive power output to be provided to the electric drive system 106 by the power circuit 406 of the SM 402, and then operates the electronic power switches of the power circuit 406 (i.e., operates switches of the DC-to-AC inverter via PWM signals) to provide the proportional drive power output. If the power controller 404 is not provided, then the PCS controller 430 is configured to determine the proportional drive power output for each SM 402 and to control the electronic power switches of the power circuits 406 of the SMs 402 to provide the proportional drive power output.

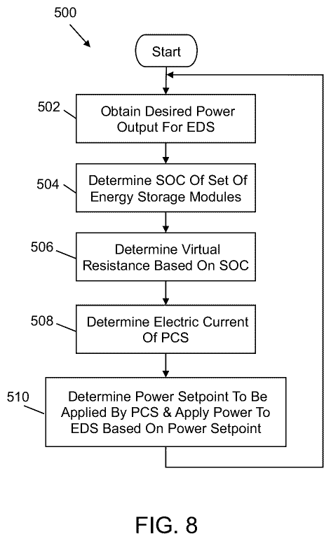

Referring to FIG. 8, an example control routine 500 for a PCS 120 and more particularly, for providing power to the electric drive system 106 is provided. At 502, the PCS 120 obtains a desired power output for the electric drive system (EDS) 106. As provided above, the desired power output can be provided in various forms such as, but not limited to, reference voltage, a reference current, and is determined based on one or more operating conditions of the electric drive system 106. At 504, using known methods, the PCS 120 determines a SOC or an equivalent SOC of the set of energy storage modules 114 that the PCS 120 is connected to. At 506, the PCS 120 is configured to determine a required value of the virtual resistance (Rᵥᵢᵣ) based on the SOC. For example, Rᵥᵢᵣ=K/SOC, where K is a global constant used be each PCS 120. At 508, the PCS 120 is configured to obtain a value of electric current provided by the PCS 120. For example, the PCS 120 may include a current sensor for measuring a supplied current (iᵢₙᵥ) by the PCS 120. At 510, the PCS 120 is configured determine the power setpoint to be applied by the PCS 120, and then applies power to the electric drive system 106. For example, the power setpoint can be provided vᵢₙᵥ, and is determined as vᵢₙᵥ=V_{ref}−(iᵢₙᵥ×Rᵥᵢᵣ), where V_{ref} is the desired power output. The PCS 120 may continue the control routine 500 until, for example, power to the vehicle is turned-off.

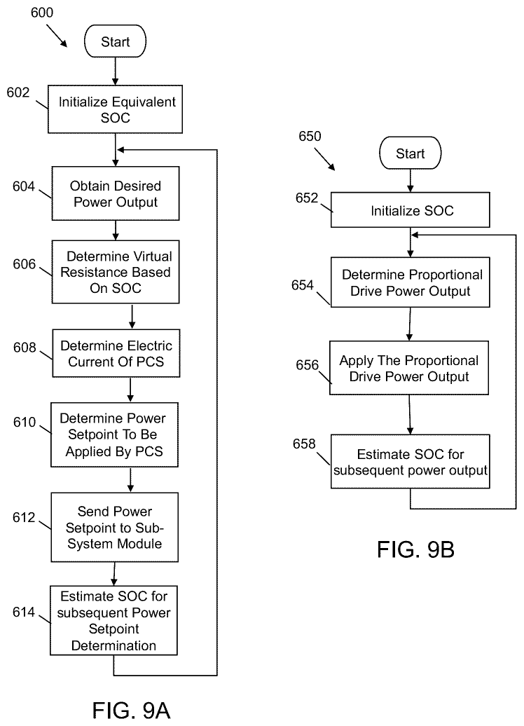

Referring to FIGS. 9A and 9B example control routines 600 and 650 are provided for the electric power system 100 having the PCS 400, where the control routine 600 is executed by the PCS controller 430 and the routine 650 is executed by each SM 402 of the PCS 400 via the power controller 404. For routine 600, the PCS controller 430, at 602, initializes an equivalent SOC for the respective PCS 400, where SOC=1. Steps 604, 606, and 608 are similar to steps 502, 506, and 508 of FIG. 5. Specifically, at 604, the PCS 120 obtains a desired power output for the electric drive system (EDS) 106; at 606, the PCS 120 is configured to determine a required value of the virtual resistance (Rᵥᵢᵣ) based on the SOC; and at 608 the PCS 120 is configured to obtain a value of electric current provided by the PCS 120. At 610, the PCS controller 430 is configured to determine power setpoint to be applied by the PCS 400 based at least on the desired power output and the SOC. For example, the PCS controller 430 determines voltage of the inverter as vᵢₙᵥ=V_{ref}−(iᵢₙᵥ×Rᵥᵢᵣ) and then determines voltage based on the number of modules as v_{c}=Vᵢₙᵥ/(N*SOC), where N is the number of SMs 402 provided in the PCS 400. At 612, the PCS controller 430 provides “v_{c}” as the power setpoint to each SM 402 of the PCS 400. At 614, The PCS 230 then estimates the SOC of the set of energy storage modules 114 coupled to the PCS 400. For example, the PCS 230 measures voltage applied at the current power cycle as “v_{A}” and determines or estimates the SOC as, SOC=v_{A}/(v_{c}*N). The estimated SOC is used to determine a subsequent power setpoint.

Referring to FIG. 9B, with the power setpoint for the PCS 400, each SM 402 of the PCS 400 is configured to perform routine 650 to determine a proportional drive power output to be provided to the electric drive system 106 by the SM 402. At 652, the SM 402 is configured to initialize the SOC or determine the SOC of the subset of energy storage modules 114 coupled to the SM 402. At 654, the SM 402 is configured determine the proportional drive power output based on the power setpoint and the SOC of the subset of energy storage modules 114. For example, the proportional drive power output can be provided as voltage “vₒₚ” where vₒₚ=v_{c}*SOC. At 656, the proportional drive power output is provided to the electric drive motor 118 and current supplied to the electric drive motor is measured (supplied current is “i”). At 658, the SM 402 is configured to estimate the SOC of the subset of energy storage modules. For example, the SOC can be estimated by (17) below, where “i” is the supplied current and C peak charge capacity of the subset of energy storage modules 114. The estimated SOC is used to determine the proportional drive power output for a subsequent power determination.

$$\\ \begin{matrix}{SOC}_{est} = SOC - \frac{{\int }_{{t}_{0}}^{{t}_{0} + T} idt}{C} & ( 17 )\end{matrix}$$

The routine of FIGS. 9A and 9B can be employed for electric power systems in which there is a PCS 400 and the PCS controller 430 at least has a single direction communication with each SM 402. The PCS 400 may continue the control routines 600 and 650 until, for example, power to the vehicle is turned-off. In the event the there is no power controller at the SMs 402, the PCS controller 430 can be configured to determine the proportional drive power output for each SM 402 in a similar manner as that described with respect to the control routine 650.

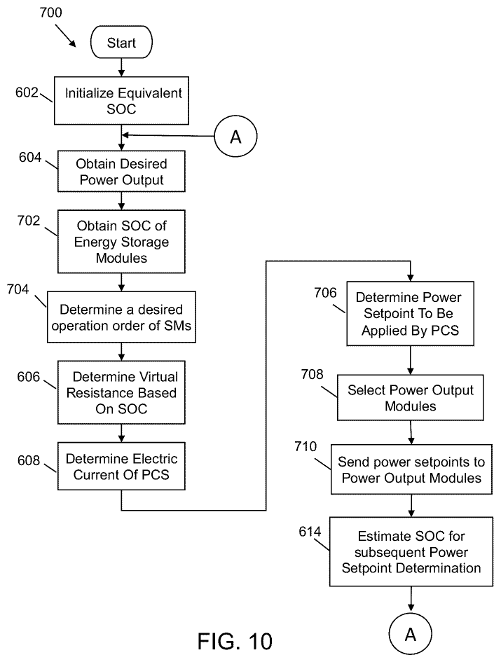

In another variation, if each SM 402 is able to transmit data to the PCS controller 430 (i.e., there is dual-way communication between PCS controller 430 and the SMs 402), the PCS controller 430 may obtain data indicative of the SOC of the subset of energy storage modules for each SM 402, and may then selectively operate the SMs 402 based on the SOC. For example, FIG. 10 illustrates a control routine 700 executed by the PCS controller 430 that is able to receive data indicative of SOC from the SMs 402 of the PCS 400. The portions of the control routine 700 are similar to portions of the control routine 600, and therefore, steps provided in routine 700 that are the same as those of routine 600 not be described in detail. At 702, the PCS controller 430 is configured to obtain the SOC of the subset of energy storage modules coupled to each of the SMs 402 from the SMs 402, and at 704 determine a desired operation order of the SMs 402. More particularly, the PCS controller 430 sorts a list of the SMs 402 based on the SOC associated with each SMs 402. At 706, similar to routine 500, the PCS controller 430 determines a power setpoint for the PCS 400 as vᵢₙᵥ=V_{ref}−(iᵢₙᵥ×Rᵥᵢᵣ).

Using information related to the SOC of the SMs 402, the PCS controller 430 is configured to select SMs 402 to provide the power to the electric drive system. Specifically, at 708, the PCS controller 430 selects one or more SMs 402 from among the plurality of SMs 402 of the PCS 400, as power output modules, based on the desired operation order and the power setpoint. For example, the PCS controller 430 determine how many SMs 402 will be fully ON (FON) to obtain the power setpoint as F_{ON}=fix(vᵢₙᵥ/B), where B is the max power of the SM 402. The PCS controller 430 further determines the remaining power needed to reach the power setpoint. For example, the remaining voltage (V_rem), as the remining power, is provided as V_rem=rem (vᵢₙᵥ/B). At 710, the PCS 230 transmits the power setpoint to the power output modules. Once received, the SMs 402 selected as the power output modules are configured to operate in a similar manner as provided in routine 9B, with the main distinction being that the SMs transmit the estimated SOC to the PCS 230.

In some variations, in which the SMs 402 have dual communication with the PCS 400, the PCS controller 430 is further configured to selectively operate the power output modules such that one or more power output module 402 is switching ON-OFF at a time to improve switching frequency. More particularly, the PCS controller 430 is configured to assign a status to each power output module based on, for example, load demands of the electric drive system and a state of the subset of energy storage modules. That is, for a selected time period, the status indicates whether the power output module is to be actively ON or actively switching ON-OFF. The state of the subset of energy storage modules includes health of the energy storage module, a SOC of the subset of energy storage modules, and/or performance characteristics of the subset of energy storage modules 114 such as temperature. Accordingly, for the selected time period, a first set of power output modules is provided with a status of actively ON while a second set of power output modules different from the first set of power output module is provided with a status of actively switching ON-OFF. Stated differently, the first set of power output modules are actively ON while the second state of power output modules are actively switching ON-OFF to provide the drive power output during the selected time period.

In one form, the PCS 120 and PCS 400 can be used in combination with each other to form the electric power system(s) 100. For example, the vehicle 102 can include an electric power system having PCSs 120 for a first motor and another electric power system having PCSs 400 for a second motor. Both PCS 120 and 400 can be employed to provide power to the same motor.

It should be readily understood that the example routines of FIGS. 8, 9A, 9B, and 10 are provided as examples, and that the control routines may be configured in other suitable ways for controlling power to the electric drive system.

The electric power system of the present disclosure may provide modular and/or scalable hardware design with distributed software control. In some applications, the electric power system may not require filtering, thus reducing size of the system and complexity. The control methodology described herein may enable active and/or selective management of the power conversion systems, which can increase the capacity of the energy storage modules and/or drive range of the vehicle. These and other benefits may be provided with the electric power system of the present disclosure.

In the present disclosure, the term “obtain” may at least include to receive from another device, calculate based on data received, and/or determine based a software application.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An electric power system for a vehicle, the vehicle including a power bus, an electric drive system, and an energy storage pack, the electric power system comprising:
one or more power conversion systems electrically connected in parallel for each phase of an electric motor of the electric drive system, wherein each power conversion system is electrically coupled to a set of energy storage modules from among a plurality of energy storage modules of the energy storage pack, and wherein each power conversion system includes:
a power circuit electrically coupled to a respective set of energy storage modules and configured to provide a drive power output to the electric drive system and an auxiliary power output to the power bus, and
a power controller configured to control the power circuit to provide the drive power output based on a desired power output of the electric drive system.

2. The electric power system of claim 1, wherein the power circuit includes a three-level direct current-to-alternating current (DC-to-AC) inverter configured to provide the drive power output.

3. The electric power system of claim 1, wherein the power circuit includes a direct current-to-direct current (DC-to-DC) converter configured to provide the auxiliary power output to the power bus.

4. The electric power system of claim 3, wherein the DC-to-DC converters of the power circuits of at least two power conversion systems from among the one or more power conversion systems are electrically coupled in series to provide respective auxiliary power outputs to the power bus.

5. The electric power system of claim 3, wherein the DC-to-DC converters of the power circuits of at least two power conversion systems from among the one or more power conversion systems are electrically coupled in parallel to provide respective auxiliary power outputs to the power bus.

6. The electric power system of claim 3, wherein:
the vehicle includes a plurality of power buses, and
the DC-to-DC converters of the power circuits of at least two power conversion systems from among the one or more power conversion systems are electrically coupled to provide respective auxiliary power outputs to a first power bus from among the plurality of power buses, and
the DC-to-DC converter of the power circuit of a third power conversion system from among the one or more power conversion systems is configured to provide respective auxiliary power output to a second power bus from among the plurality of power buses.

7. The electric power system of claim 1, wherein the power circuit includes:
a three-level direct current-to-alternating current (DC-to-AC) inverter configured to provide the drive power output, and
a direct current-to-direct current (DC-to-DC) converter configured to provide the auxiliary power output to the power bus, wherein the DC-to-AC inverter and the DC-to-DC converter are electrically isolated from each other.

8. The electric power system of claim 1, wherein the vehicle includes a plurality of power buses:
the power circuit of a first power conversion system from among the one or more power conversion systems is configured to provide a respective auxiliary power output to a first power bus from among the plurality of the power buses, and
the power circuit of a second power conversion system from among the one or more power conversion systems is configured to provide a respective auxiliary power output to a second power bus from among the plurality of the power buses.

9. The electric power system of claim 1, wherein:
each power conversion system includes a plurality of the power circuits and a plurality of the power controllers forming a plurality of sub-system modules configured to provide the drive power output and the auxiliary power output, wherein each sub-system module among the plurality of sub-system modules includes:
one power circuit from among the plurality of the power circuits, electrically coupled to a subset of energy storage modules, wherein the subset of energy storage modules is selected from among the set of energy storage modules, and
one power controller from among the plurality of the power controllers configured to control the one power circuit.

10. The electric power system of claim 1, wherein the power controller of the power conversion system is configured to:
obtain a desired power output, wherein the desired power output is based on an operating condition of the electric drive system,
determine a state of charge of each energy storage module of the set of energy storage modules; and
determine a power setpoint to be provided by the power conversion system based on the desired power output and the state of charge of the set of energy storage modules.

11. The electric power system of claim 10, wherein the power controller is configured to determine a virtual resistance based on the state of charge of the set of energy storage modules, wherein the power setpoint is further determined based on the virtual resistance.

12. The electric power system of claim 10, wherein the power controller is configured to determine an estimated state of charge of each energy storage module in response to the drive power output being applied to the electric drive system, wherein a subsequent power setpoint is determined based on the estimated state of charge.

13. A system comprising:
an electric drive system including an electric motor; and
the electric power system of claim 1, wherein the one or more power conversion systems is provided for each phase of the electric motor.

14. An electric power system for a vehicle, the vehicle including a power bus, an energy storage pack, and an electric drive system, the electric power system comprising:
one or more power conversion systems electrically connected in parallel for each phase of an electric motor of the electric drive system, wherein each power conversion system is electrically coupled to a set of energy storage modules from among a plurality of energy storage modules of the energy storage pack, and wherein each power conversion system includes:
a plurality of sub-system modules electrically coupled to provide a drive power output to the electrical drive system and an auxiliary power output to the power bus, each sub-system module comprising:
a power circuit electrically coupled to a subset of energy storage modules and configured to provide a proportional drive power output and a proportional auxiliary power output to the power bus, wherein the subset of energy storage modules is selected from among the set of energy storage modules, and
a power controller configured to control the power circuit to provide the proportional drive power output based on a desired power output of the electric drive system, wherein:
the proportional drive power outputs from the plurality of sub-system modules are provided as the drive power output, and
the proportional auxiliary power output from the plurality of sub-system modules is provided as the auxiliary power output.

15. The electric power system of claim 14, wherein the power controller for a sub-system module of the plurality of sub-system modules is configured to:
obtain a power setpoint for a respective power conversion system, wherein the power setpoint is based on the desired power output of the electric drive system; and
determine the proportional drive power output to be provided to the electric drive system by the power circuit based on the power setpoint and a state of charge of the subset of energy storage modules.

16. A method for providing power to a vehicular electric drive system employing an electric power system, the method comprising:
obtaining a desired power output of the electric power system, wherein the electric power system includes one or more power conversion systems, each power conversion system is electrically coupled to a set of energy storage modules from among a plurality of energy storage modules; and
for each power conversion system:
obtaining a state of charge of each energy storage module of the set of energy storage modules; and
determining a power setpoint to be provided by each power conversion system based on the desired power output and the state of charge of the set of energy storage modules.

17. The method of claim 16 further comprising, for each power conversion system, determining a virtual resistance based on the state of charge of the set of energy storage modules, wherein the power setpoint is further determined based on the virtual resistance.

18. The method of claim 16 further comprising:
providing power to the vehicular electric drive system by the electric power system based on the power setpoint; and
determining an estimated state of charge of each energy storage module in response to providing power to the vehicular electric drive system, wherein a subsequent power setpoint is determined based on the estimated state of charge.

19. The method of claim 16 further comprising, for each power conversion system:
measuring a voltage applied to the vehicular electric drive system; and
determining an estimated state of charge of the set of energy storage modules based on the voltage applied and the power setpoint, wherein a subsequent power setpoint is determined based on the estimated state of charge.

20. The method of claim 16, wherein each power conversion system includes a plurality of sub-system modules electrically coupled to a subset of energy storage modules among the set of energy storage modules, and the method further comprises:
obtaining, by each sub-system module, the power setpoint for a respective power conversion system; and
determining, by each sub-system module of the respective power conversion system, a proportional drive power output to be provided to the vehicular electric drive system by the sub-system module based on the power setpoint and a state of charge of the subset of energy storage modules electrically coupled to the sub-system module.

21. The method of claim 20 further comprising, by each sub-system module among the plurality of sub-system modules:
measuring an applied current to the vehicular electric drive system in response to applying the proportional drive power output; and
determining an estimated state of charge of the subset of energy storage modules based on the applied current and a peak charge capacity of the subset of the energy storage modules, wherein a subsequent proportional drive power output is determined based on the estimated state of charge of the subset of energy storage modules.

22. The method of claim 16, wherein each power conversion system includes a plurality of sub-system modules electrically coupled to a subset of energy storage modules among the set of energy storage modules, and the method further comprises:
obtaining a state of charge of the subset of energy storage modules from each sub-system module from among the plurality of sub-system modules;
determining a desired operation order of the sub-system modules based on the state of charge obtained;
selecting one or more sub-system modules from among the plurality of sub-system modules, as power output modules, based on the desired operation order and the power setpoint;
determining, for each power output module, a proportional drive power setpoint to be provided to the vehicular electric drive system based on the power setpoint; and
providing the proportional drive power setpoint to the respective power output sub-system module.

23. The method of claim 22 further comprising:
assigning a status to each power output module based on load demands and a state of the subset of energy storage modules, wherein the status is selected from among actively ON and actively switching ON-OFF.

24. The method of claim 23 further comprising:
providing a first set of power output modules with a status of actively ON during a selected time period while providing a second set of power output modules different from the first set of power output module with a status of actively switching ON-OFF during the selected time period.

25. The method of claim 24, wherein each of the first set of power output modules and the second set of power output modules includes at least one power output module.
